(19) United States
(12) Patent Application Publication
(10) Pub. No.: US 2018/0352278 A1
(43) Pub. Date: Dec. 6, 2018

(54) PERSONALIZED MESSAGING MANAGEMENT SYSTEM FOR ENHANCED USER ENGAGEMENT IN A SUBSCRIBED NETWORK

(71) Applicant: Sony Interactive Entertainment LLC, San Mateo, CA (US)

(72) Inventors: Daniel Myers, San Mateo, CA (US); Erin Ashley Metzger, San Mateo, CA (US); Ripin Mohan Natani, San Mateo, CA (US)

(21) Appl. No.: 15/517,802

(22) PCT Filed: Feb. 23, 2017
(86) PCT No.: PCT/US17/19091

§ 371 Date: Apr. 7, 2017

Related U.S. Application Data
(60) Provisional application No. 62/298,791, filed on Feb. 23, 2016.

(51) Int. Cl. H04N 21/2668; H04N 21/258; H04N 21/222

(52) U.S. Cl. CPC H04N 21/2668; H04N 21/222; H04N 21/25883

(57) ABSTRACT

A messaging management system and method for enhanced user engagement are disclosed, which includes generation of a personalized multimedia message for a first consumer electronic (CE) device of a plurality of CE devices. The first CE device is associated with a first subscriber account of a plurality of subscriber accounts. The personalized multimedia message is generated based on a plurality of segmentation parameters for a plurality of users. Display of the personalized multimedia message on the first CE device associated with the first subscriber account, is controlled to enhance user engagement.

### CROSS-REFERENCE TO RELATED APPLICATIONS/INCORPORATION BY REFERENCE

This application claims priority to U.S. Provisional Patent Application Ser. No. 62/298,791 filed on Feb. 23, 2016, the entire content of which is hereby incorporated by reference.

### FIELD

Various embodiments of the disclosure relate to a messaging management system. More specifically, various embodiments of the disclosure relate to a personalized messaging management system for enhanced user engagement in a subscribed network.

### BACKGROUND

With the advent of digital convergence in the field of messaging systems and consumer engagement technologies, it has become possible to interface with consumers via various modes of communication. Traditionally, consumer engagement has been achieved through television, radio, outdoor advertising, and various other touch points. As a result of penetration of new technologies in the television, gaming, and media distribution sector, it is evident that the success of a new product or service will be dependent on the ability of the product or service provider to gain access to the content that consumers demand, and to differentiate their offering from competitors by developing technologies for enhanced consumer experience, engagement and retention. As technology continues to evolve, many of the conventional consumer engagement techniques and practices that supported the consumer engagement online or offline, such as bulk messaging broadcast, static information or pre-filled profiles based user targeting, and loyalty programs, have become less effective in recent years. Thus, an advanced messaging management system may be required that is capable of accurately identifying an appropriate consumer at an appropriate time to provision a suitable type of personalized message in a subscribed network to enhance consumer engagement.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A personalized messaging management system and method for enhanced user engagement in a subscribed network is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for a messaging management system for enhanced user engagement, in accordance with an embodiment of the disclosure.

FIG. 2 is a block diagram that illustrates an exemplary messaging management system for enhanced user engagement, in accordance with an embodiment of the disclosure.

FIG. 3 is a block diagram that illustrates an exemplary consumer electronic device, in accordance with an embodiment of the disclosure.

FIGS. 4A and 4B are block diagrams that illustrate exemplary scenarios for implementation of the disclosed messaging management system and method for enhanced user engagement in a subscribed network, in accordance with an embodiment of the disclosure.

FIG. 5 is a flowchart that illustrates exemplary operations for messaging management in the messaging management system of FIG. 2, to provision personalized multimedia messages for enhanced user engagement in a subscribed network, in accordance with an embodiment of the disclosure.

### DETAILED DESCRIPTION

Various implementations may be found in a personalized messaging management system and method for enhanced user engagement in a subscribed network. Various embodiments of the disclosure provide a system and a method that simplifies messaging management, and provides a service provider with an ability to accurately and proactively identify a right consumer from thousands or millions of consumers to provision a right type of personalized message at a right time in a subscribed network to enhance consumer engagement, retention, and to increase appeal of their services or products in order to gain wider consumer base.

Exemplary aspects of the disclosure may comprise a messaging management method implemented in messaging management systems that handles user-information and campaigns for a plurality of users associated with a plurality of subscriber accounts. The messaging management system includes one or more processors configured to generate, based on a plurality of segmentation parameters for the plurality of users, a personalized multimedia message specifically for a first consumer electronic (CE) device of a plurality of CE devices. The first CE device may be associated with a first subscriber account of the plurality of subscriber accounts. The messaging management system may be communicatively coupled to the plurality of CE devices. The one or more processors may be further configured to control display of the personalized multimedia message on the first CE device associated with the first subscriber account.

In accordance with an embodiment, the plurality of segmentation parameters for the plurality of users may correspond to a geographical location, an age group, a language preference, a gender, a specified user-interest, a type of subscription account, and a device-type of the plurality of CE devices associated with the plurality of subscriber accounts. The plurality of segmentation parameters may further correspond to a list of products or services owned by a user associated with the first subscriber account, a time period elapsed from a registration date for a trial of a product or a service associated with the first subscriber account, or a lifetime value of the user associated with the first subscriber account.

In accordance with an embodiment, the plurality of users associated with the plurality of CE devices and the plurality of subscriber accounts may be classified based on the plurality of segmentation parameters. In some embodiments, the personalized multimedia recommendation may be generated based on the device-type of the first CE device and at least the list of products or services owned by a user associated with the first subscriber account. In some embodiments, the personalized multimedia recommendation may be generated based on the device-type of the first CE device and a time period elapsed from the registration date for the trial of a product or a service associated with the first subscriber account. In some embodiments, the personalized multimedia recommendation may be generated based on the device-type of the first CE device and a lifetime value of the user associated with the first subscriber account.

In accordance with an embodiment, a multimedia recommendation may be provisioned to a target group of CE devices among the plurality of CE devices in accordance with the plurality of segmentation parameters. The one or more processors may be configured to detect a change in a selection of a subscription feature associated with the first subscriber account in real time, near-real time, or a lag time. Thereafter, a personalized multimedia message may be generated and communicated in real time, near-real time or a lag time to the first CE device associated with the first subscriber account based on the detected change in the selection of the subscription feature associated with the first subscriber account.

In accordance with an embodiment, the one or more processors are further configured to detect a change in a trend in viewing habits of one or more users associated with the first subscriber account. Thereafter, a personalized multimedia message may be generated and communicated in real time, near-real time or a lag time to the first CE device associated with the first subscriber account based on the detected change in the trend in viewing habits of the one or more users associated with the first subscriber account. A placement of different content types for display of the personalized multimedia message may be determined based on a selected layout, from a plurality of specified layouts, specified for a device-type of the first CE device.

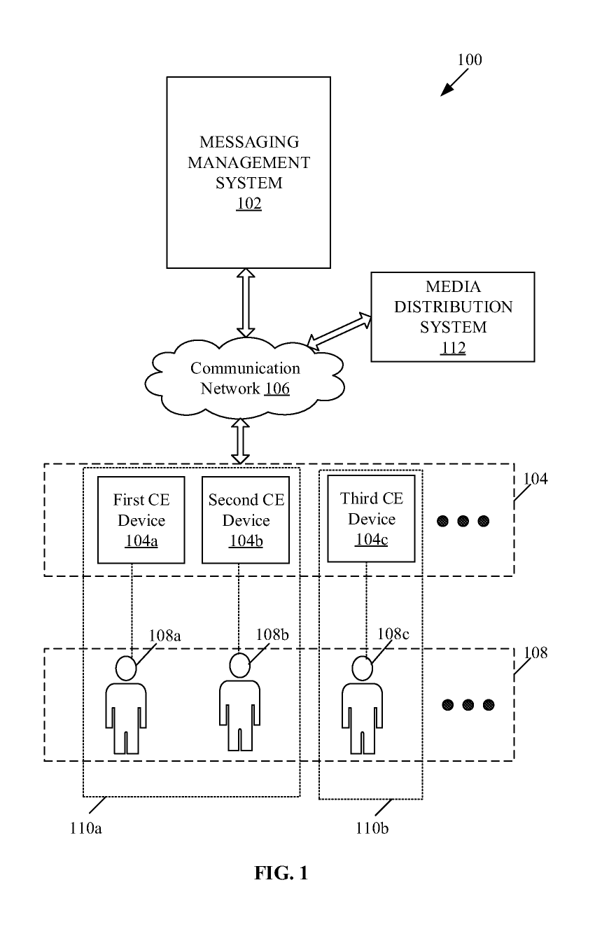

FIG. 1 is a block diagram that illustrates an exemplary network environment for a messaging management system for enhanced user engagement, in accordance with an embodiment of the disclosure. With reference to FIG. 1, there is shown an exemplary network environment 100. The exemplary network environment 100 may include a messaging management system 102, a plurality of consumer electronic (CE) devices 104, such as a first CE device 104a, a second CE device 104b, and a third CE device 104c. There is also shown a communication network 106. The plurality of CE devices 104 may be communicatively coupled to the messaging management system 102, via the communication network 106. A plurality of users 108 may be associated with the plurality of CE devices 104. For example, a first user 108a, a second user 108b, and a third user 108c of the plurality of users 108 may be associated with the first CE device 104a, the second CE device 104b, and the third CE device 104c, respectively, as shown. The plurality of CE devices 104 and the plurality of users 108 may also be associated with a plurality of subscriber accounts. A first subscriber account 110a, a second subscriber account 110b, and a media distribution system 112 is also shown in the exemplary network environment 100.

The messaging management system 102 may comprise suitable logic, circuitry, interfaces, and/or code that may be configured to communicate with the plurality of CE devices 104, via the communication network 106. The messaging management system 102 may be configured to classify the plurality of users 108 associated with the plurality of CE devices 104 and the plurality of subscriber accounts based on a plurality of segmentation parameters. The messaging management system 102 may be configured to accurately and efficiently identify an appropriate consumer at an appropriate time and provision a suitable personalized multimedia message to a CE device associated with the identified consumer in a subscribed network. An example of the messaging management system 102 may be a messaging management server operated by a service provider.

Each of the plurality of CE devices 104 may comprise suitable logic, circuitry, interfaces, and/or code that may be configured to communicate with the messaging management system 102, via the communication network 106. Each of the plurality of CE devices 104 may communicate one or more requests to subscribe for a service, such as an over-the-top content (OTT)-based television (TV) service or an online gaming service, to the messaging management system 102. The messaging management system 102 may be configured to seek user-information from the plurality of users 108 at the time of subscription account creation, such as the first subscriber account 110a operated by the service provider. Examples of the plurality of CE devices 104 may include, but are not limited to, a video game console, a mobile device, such as a smart phone, a tablet computer, a web-enabled device, a laptop, a wearable electronic device, Internet Protocol television (IPTV), and/or other computing or display devices.

The communication network 106 may include a communication medium through which the messaging management system 102 may communicate with the plurality of CE devices 104. The communication network 106 may be a wired or wireless communication network. Examples of the communication network 106 may include, but are not limited to, a Wireless Fidelity (Wi-Fi) network, a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), a Metropolitan Area Network (MAN), and/or the Internet. Various devices in the exemplary network environment 100 may be configured to connect to the communication network 106, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, Long Term Evolution (LTE), Light Fidelity (Li-Fi), and/or other cellular communication protocols including variants thereof.

The media distribution system 112 may comprise suitable logic, circuitry, and interfaces that may be configured to distribute media content comprising audio, video, images, metadata, and/or other embedded or externally referenced data. The media distribution system 112 handles distribution, for example, streaming, for a plurality of channels to be viewed on one or more of the plurality of CE devices 104. In some embodiment, the media distribution system 112 may also be configured to stream online games or other media content to the plurality of CE devices 104. In some embodiments, the media distribution system 112 may be the service provider and configured to receive media content from a plurality of broadcast providers or network operators and then further distribute, for example, via Internet (e.g. OTT) to the plurality of CE devices 104. In some embodiments, the media distribution system 112 may be operated by one of the plurality of broadcast providers or network operators.

In operation, one or more of the plurality of CE devices 104 may be configured to communicate one or more requests to subscribe for a service to the messaging management system 102. The messaging management system 102 may be configured to render one or more user interfaces (UIs) or application interfaces to allow input of user-information from one or more of the plurality of CE devices 104 at the time of subscription account creation. The plurality of CE devices 104 and the plurality of users 108 may also be associated with the plurality of subscriber accounts. In some embodiments, a set of CE devices from the plurality of CE devices 104 may be associated with a common subscriber account. In some embodiments, each of the plurality of CE devices 104 and the plurality of users 108 may be associated with different subscriber accounts. For example, the first CE device 104a and the second CE device 104b may be associated with a common subscriber account, such as the first subscriber account 110a. The messaging management system 102 may be configured to create a master profile for the first user 108a associated with the first CE device 104a and a sub-profile for the second user 108b associated with the second CE device 104b based on an input that corresponds to the user-information received from the first CE device 104a or the second CE device 104b. For example, different family members may be registered to access the first subscriber account 110a using their own login profile. A user, such as the first user 108a, may be considered the master user if the user made the buying decision for the first subscriber account 110a and was the first to create a profile (referred to as the master profile) at the time of subscription to the first subscriber account 110a. Any subsequent user, such as the second user 108b, registered in the same subscription account, such as the first subscriber account 110a, may be classified as sub-users (also referred to as child user) and their individual profile may be classified as sub-profiles of the master profile. The third CE device 104c may be associated with a different subscriber account, such as the second subscriber account 110b. The messaging management system 102 may be configured to receive user-information for the third user 108c associated with the third CE device 104c based on the user-information provided to at the time of subscription for the second subscriber account 110b. Similar to the CE devices 104a, 104b, and 104c, the messaging management system 102 may be configured to receive user-information for the plurality of users 108 associated with the plurality of CE devices 104 and the plurality of subscriber accounts.

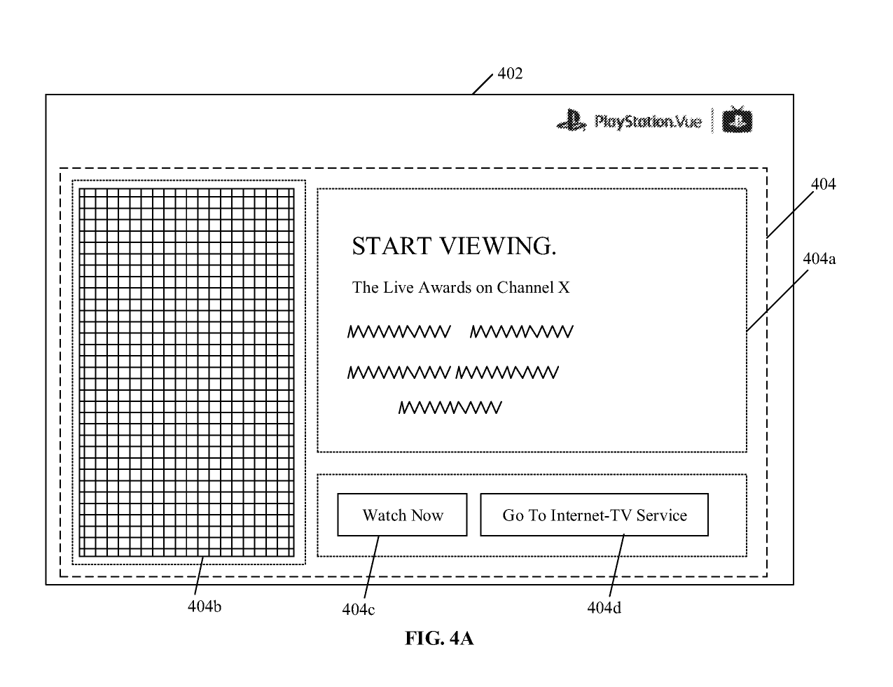

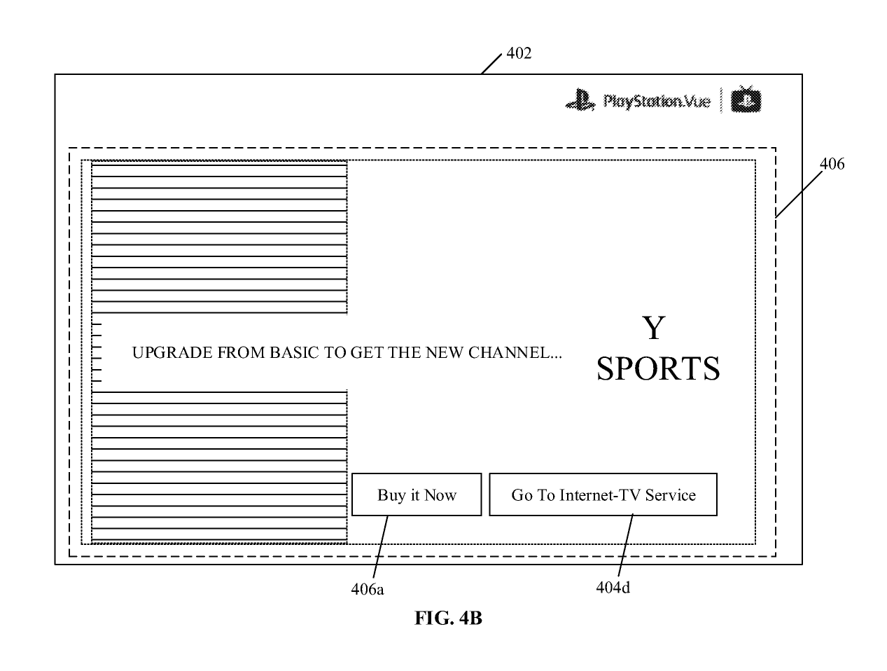

Based on the received user-information for the plurality of users 108 associated with the plurality of subscriber accounts, the messaging management system 102 may be configured to check whether each of the plurality of users 108 associated with the plurality of subscriber accounts are new consumers or existing consumers for some other products or services provided by the service provider. For example, the first user 108a may also own other products, such as a gaming console, from the same or a related entity that provides the service associated with the first subscriber account 110a. Thus, a wealth of data, such as user-interests, likes, dislikes, version of current products owned, type of other subscription accounts owned or previously discontinued, may be available for such users, such as the first user 108a, which may be utilized to generate insights. The messaging management system 102 may be configured to retrieve input parameters for the first user 108a associated with the first CE device 104a based the user-information provided at the time of subscription for the first subscriber account 110a. Similarly, the messaging management system 102 may be configured to retrieve the input parameters for the plurality of users 108 associated with the plurality of CE devices 104, based on user-information provided at the time of subscription for the plurality of subscriber accounts. An example of the input parameters is described in detail in FIG. 4A.

The messaging management system 102 may be configured to classify the plurality of users 108 associated with the plurality of CE devices 104 and the plurality of subscriber accounts based on a plurality of segmentation parameters. The messaging management system 102 may be configured to utilize the retrieved input parameters for the plurality of users 108 and the plurality of segmentation parameters for the classification. The plurality of segmentation parameters for the plurality of users 108 may correspond to a geographical location, an age group, a language preference, a gender, and specified user-interests of each of the plurality of users 108. The plurality of segmentation parameters for the plurality of users 108 may further include a type of subscription account and a device-type of the plurality of CE devices 104 owned by the plurality of users 108. The type of subscription account refers to a level-of-use, access level, or a type of subscription package, such as a basic or a premium subscription package.

In accordance with an embodiment, the plurality of segmentation parameters may further correspond to a list of products or services owned by each of the plurality of users 108 associated with the plurality of subscriber accounts. The plurality of segmentation parameters may also include a time period elapsed from a registration date for a trial of a product or a service associated with each subscriber account of the plurality of subscriber accounts. The plurality of segmentation parameters may also include a lifetime value of each consumer, such as each of the plurality of users 108 associated with at least one of the plurality of subscriber accounts.

In accordance with an embodiment, the messaging management system 102 may be configured to generate, based on the plurality of segmentation parameters for the plurality of users 108, a personalized multimedia message specifically for each CE device of the plurality of CE devices 104. For example, the messaging management system 102 may be configured to generate a personalized multimedia message specifically for the first CE device 104a of the plurality of CE devices 104, where the first CE device 104a is associated with at least one subscriber account, such as the first subscriber account 110a, of the plurality of subscriber accounts. In some embodiments, the messaging management system 102 may be configured to generate the personalized multimedia message based on the device-type of the first CE device 104a, such as mobile, tablet, or a gaming device, and at least a list of products or services owned by a user, such as the first user 108a, associated with the first subscriber account 110a. The messaging management system 102 may be configured to generate the personalized multimedia message further based on the device-type of the first CE device 104a and a time period elapsed from a registration date for the trial of a product or a service associated with the first subscriber account 110a. In some embodiments, the messaging management system 102 may be configured to generate the personalized multimedia message based on the lifetime value of the first user 108a associated with the first subscriber account 110a.

The messaging management system 102 may be configured to control display of the personalized multimedia message on the first CE device 104a associated with the first subscriber account 110a. The messaging management system 102 may be configured to determine a placement of different content types for display of the personalized multimedia message. The placement of different content types, such as an animation, a video, an audio, text, image, graphics, or the like, may be determined based on a layout specified for the device-type of the first CE device 104a. The layout may refer to a particular template that may be selected from a plurality of specified layouts in accordance to the device-type of the CE device where the personalized multimedia message is to be rendered.

The messaging management system 102 may be configured to detect a change in a selection of a subscription feature associated with the first subscriber account 110a in real time, near-real time, or a lag time. For example, if a user discontinues a particular subscribed channel or decides to discontinue a trial service, the messaging management system 102 may detect such changes in real time or near-real time. Thereafter, the messaging management system 102 may be configured to generate and communicate a personalized multimedia message in real time, near-real time or a lag time to the first CE device 104a associated with the first subscriber account 110a (or other CE devices associated with the detected changes) based on the detected change in the selection of the subscription feature associated with the first subscriber account 110a.

In accordance with an embodiment, the messaging management system 102 may be configured to detect a change in a trend in viewing habits of one or more users associated with the first subscriber account 110a. Thereafter, based on the detected change in the trend in viewing habits of the one or more users, such as the first user 108a and the second user 108b, the messaging management system 102 may be configured to generate a personalized multimedia message for the first CE device 104a that is associated with the first subscriber account 110a. The messaging management system 102 may be configured to communicate the generated personalized multimedia message to the first CE device 104a associated with the first subscriber account 110a in real time or near-real time based on the detected change.

In accordance with an embodiment, the messaging management system 102 may be configured to provision a multimedia message to a target group of CE devices among the plurality of CE devices 104 in accordance with the plurality of segmentation parameters. For example, the subscribed users who belong to certain geographical locations, for example, New York and Philadelphia, and who view their service, such as an Internet-based TV service, associated with their subscriber accounts particularly from their gaming consoles, may be the target group of CE devices to which the multimedia recommendation may be communicated. The multimedia message may be a multimedia recommendation, an upsell message, or a customized message. For example, the multimedia recommendation may be a personalized multimedia message to promote TV programs or upcoming TV events to users associated with the target group of CE devices. The upsell message, for example, may refer to a personalized multimedia message to pitch for an upgrade in the existing subscription package, for example, from current basic to premium subscription type. The customized message may be a multimedia message personalized specifically for the target group of CE devices. For example, based on tracking of viewing-habits, likes, dislikes, and specified user-interests, certain TV programs or events may be identified as relevant to the users of the target group of CE devices. Thereafter, a customized message may be generated to promote those TV programs, events, or games, which are relevant to the users of the target group of CE devices. The generated customized message(s) may then be provisioned to the identified target group of CE devices. In certain scenarios, real events, such as an upcoming regional power outage, or events, such as a planned maintenance activity, may potentially affect service(s) of users associated with certain subscription accounts of the plurality of subscription accounts. In such scenarios, the messaging management system 102 may be configured to communicate a customized message to the target group of CE devices associated with subscription accounts that are likely to be affected.

In some embodiments, one or more combination of the plurality of segmentation parameters may be used to provision the personalized multimedia message to a selected CE device, such as the first CE device 104a or the third CE device 104c, or to the target group of CE devices of the plurality of CE devices 104. For example, users who are in their Xth day, for example 6^{th} Day, of their trial of a service (e.g. show-time trial) and who own a particular device-type or device version, such as a gaming console of version-Y, may be selected as the target users. Consider a target user, such as the first user 108a, who may login to the first subscriber account 110a on the first CE device 104a. Such personalized multimedia message may be displayed on the first CE device 104a as a first view after the login screen. In some embodiments, a view application may be installed in the first CE device 104a. The personalized multimedia message(s) may be displayed on the first CE device 104a when the view application is launched on the first CE device 104a. In some embodiments, the personalized multimedia message(s) may be displayed on the first CE device 104a as a push notification without the need to launch the view application on the first CE device 104a. In some embodiments, the personalized multimedia message(s) may be displayed on the first CE device 104a or a secondary personal device, such as a smartphone, of a target user, when the user is offline.

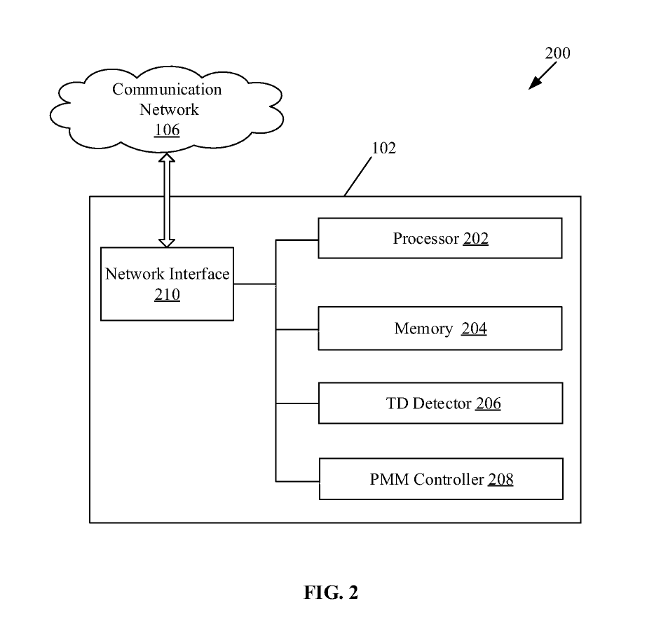

FIG. 2 is a block diagram that illustrates an exemplary messaging management system for enhanced user engagement, in accordance with an embodiment of the disclosure. FIG. 2 is described in conjunction with elements from FIG. 1. With reference to FIG. 2, there is shown a block diagram 200 of an exemplary messaging management system, such as the messaging management system 102. The messaging management system 102 may include one or more circuits, such as a processor 202, a memory 204, a target device (TD) detector 206, a personalized multimedia messaging (PMM) controller 208, and a network interface 210. There is also shown the communication network 106 (FIG. 1).

In accordance with an embodiment, the processor 202 may be communicatively coupled to the memory 204, the TD detector 206, the PMM controller 208, and the network interface 210. The network interface 210 may be configured to communicate with the plurality of CE devices 104, via the communication network 106, under the control of the processor 202.

The processor 202 may comprise suitable logic, circuitry, interfaces, and/or code that may be configured to execute a set of instructions stored in the memory 204. The processor 202 may be configured to render one or more user interfaces (UIs) or application interfaces to allow input of user-information from the one or more of the plurality of CE devices 104 at the time of subscription account creation. The processor 202 may be implemented based on a number of processor technologies, which are known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors or control circuits.

The memory 204 may comprise suitable logic, circuitry, interfaces, and/or code that may be configured to store a machine code and/or a set of instructions executable by the processor 202, the TD detector 206, or the PMM controller 208. The memory 204 may be configured to store one or more algorithms that are executed by the processor 202 to extract user-information of the plurality of users 108 associated with the plurality of CE devices 104. The memory 204 may be configured to store one or more algorithms that are executed by the TD detector 206 to identify a CE device or a target group of CE devices from the plurality of CE devices 104 to provision a personalized multimedia message to the identified CE device or the target group of CE devices. The memory 204 may be configured to store one or more algorithms that are executed by the PMM controller 208 to generate and control provisioning of the personalized multimedia message(s) to the identified CE device or the target group of CE devices. The memory 204 may be further configured to store operating systems and associated applications of the messaging management system 102. Examples of implementation of the memory 204 may include, but are not limited to, Read Only Memory (ROM), Random Access Memory (RAM), Dynamic Random Access Memory (DRAM), Static Random Access Memory (SRAM), Thyristor Random Access Memory (T-RAM), Zero-Capacitor Random Access Memory (Z-RAM), cache memory, volatile memory, a flash memory, Hard Disk Drive (HDD), a Solid-State Drive (SSD), and/or a removable media drive.

The TD detector 206 may comprise suitable logic, circuitry, interfaces, and/or code that may be configured to analyze input parameters for the plurality of users 108 associated with the plurality of subscriber accounts and the plurality of CE devices 104. The TD detector 206 may be configured to identify a CE device, such as the first CE device 104a, or a target group of CE devices from the plurality of CE devices 104 based on the plurality of segmentation parameters. The TD detector 206 may be implemented as a separate processor or special-purpose circuitry in the messaging management system 102. In some embodiments, the TD detector 206 and the processor 202 may be implemented as an integrated processor or a cluster of processors that perform the functions of the TD detector 206 and the processor 202.

The PMM controller 208 may comprise suitable logic, circuitry, interfaces, and/or code that may be configured to generate personalized multimedia messages that may be different for different users and different subscriber accounts of the plurality of subscriber accounts. For example, the PMM controller 208 may generate and control display of a personalized multimedia message specifically for the first CE device 104a associated with the first subscriber account 110a based on the plurality of segmentation parameters. The PMM controller 208 may be implemented as a separate processor or circuitry in the messaging management system 102. In some embodiments, the PMM controller 208 and the processor 202 may be implemented as an integrated processor or a cluster of processors that perform the functions of the PMM controller 208 and the processor 202.

The network interface 210 may comprise suitable logic, circuitry, interfaces, and/or code that may be configured to communicate with the messaging management system 102, via the communication network 106 (FIG. 1). The network interface 210 may be implemented by use of known technologies to support wired or wireless communication of the messaging management system 102 with the communication network 106. Components of the network interface 210 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, the processor 202 may be configured to retrieve and/or compute the input parameters for the plurality of users 108 associated with the plurality of CE devices 104, based user-information provided at the time of subscription for the plurality of subscriber accounts. An example of the input parameters is described in FIG. 4A by use of table 1 and table 2. The TD detector 206 may be configured to classify the plurality of users 108 associated with the plurality of CE devices 104 and the plurality of subscriber accounts based on the plurality of segmentation parameters and the input parameters. The PMM controller 208 may be configured to generate, based on the plurality of segmentation parameters, a personalized multimedia message specifically for a CE device or a target group of CE devices of the plurality of CE devices 104. The PMM controller 208 may be configured to control display of the generated personalized multimedia message on the identified CE device or the target group of CE devices.

In accordance with an embodiment, the TD detector 206 may be configured to detect a change in a selection of a subscription feature associated with one or more subscriber accounts in real time, near-real time, or a lag time. Thereafter, the PMM controller 208 may be configured to concurrently generate and communicate personalized multimedia messages in real time or near-real time to one or more CE devices, such as the CE devices 104a, 104b, and 104c, based on the detected change in the selection of the subscription feature associated with the one or more subscriber accounts.

In accordance with an embodiment, the TD detector 206 may be configured to detect a change in a trend in viewing habits of the plurality of users 108 associated with the plurality of subscriber accounts. The PMM controller 208 may then be configured to concurrently generate a plurality of multimedia messages that may be personalized for those users and subscriber accounts for which the change was detected. The PMM controller 208 may be configured to communicate the generated personalized multimedia messages in real time or near-real time to the CE devices associated with those subscriber accounts for which the change was detected.

In accordance with an embodiment, the TD detector 206 may be configured to determine a churn rate for the plurality of users 108 associated with the plurality of subscriber accounts. The churn rate may be determined based on the detected change in the trend(s) in viewing habits of the plurality of users 108 associated with the plurality of subscriber accounts. The determined churn rate may indicate a propensity to churn and/or a likelihood to cancel subscription after a certain duration. The users that have high likelihood to cancel their subscription may be targeted differently from the users that are not likely to cancel their subscription. The users that have high likelihood to cancel their subscription (or the determined churn rate) may correspond to one of the plurality of segmentation parameters. The PMM controller 208 may be configured to generate and communicate the generated personalized multimedia messages to the CE devices associated with those subscriber accounts for which the likelihood to cancel their subscription is determined higher than a specified threshold.

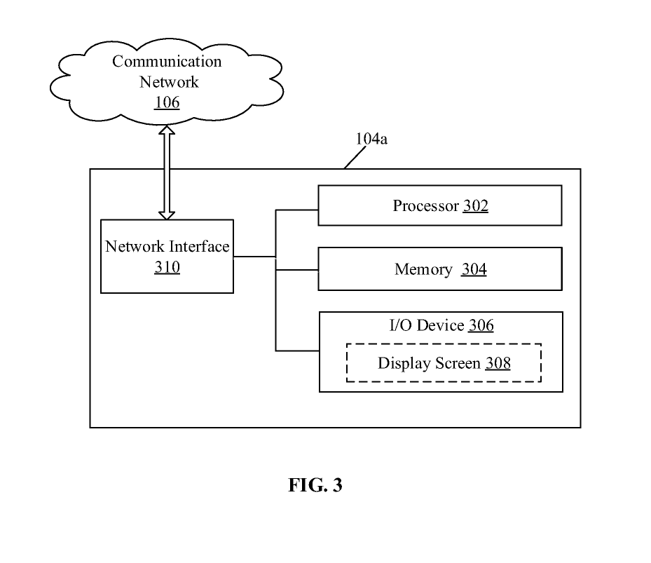

The functions and/or operations performed by the messaging management system 102, as described in FIG. 1, may be performed by the processor 202, the TD detector 206, and the PMM controller 208. Other operations by the processor 202, the TD detector 206, and the PMM controller 208, are further described, in FIGS. 3, 4A, 4B, and 5.

FIG. 3 is a block diagram that illustrates an exemplary consumer electronic device, in accordance with an embodiment of the disclosure. FIG. 3 is described in conjunction with elements from, for example, FIG. 1 and FIG. 2. With reference to FIG. 3, there is shown a block diagram of an exemplary CE device, such as the first CE device 104a. The first CE device 104a may include one or more circuits, such as a processor 302, a memory 304, an input/output (I/O) device 306, a display screen 308, and a network interface 310. The I/O device 306 may include the display screen 308.

In accordance with an embodiment, the processor 302 may be communicatively coupled to the memory 304, the I/O device 306, the display screen 308, and the network interface 310. The network interface 310 may be configured to communicate to the messaging management system 102 and the media distribution system 112, via the communication network 106.

The processor 302 may comprise suitable logic, circuitry, interfaces, and/or code that may be configured to execute a set of instructions stored in the memory 304. The processor 302 may be further configured to display one or more UIs received by the network interface 310 or the application interface of a view application stored in the memory 304. Examples of the implementation of the processor 302 may be similar to that of the processor 202 (FIG. 2).

The memory 304 may comprise suitable logic, circuitry, and/or interfaces that may be configured to store a machine code and/or a set of instructions executable by the processor 302. The memory 304 may be configured to store a view application to access a service, such as the internet-based TV service or a gaming service, associated with the first subscriber account 110a. The memory 304 may be further configured to store operating systems and associated applications of the first CE device 104a. Examples of implementation of the memory 304 may include, but are not limited to, Random Access Memory (RAM), Read Only Memory (ROM), Solid-state Drive (SSD), Hard Disk Drive (HDD), and/or a Flash memory.

The I/O device 306 may comprise suitable logic, circuitry, interfaces, and/or code that may be configured to receive an input from and provide an output to the first user 108a associated with the first CE device 104a. Examples of the input devices may include, but are not limited to, a camcorder, a touch screen, a joystick, a keyboard, a microphone, a motion sensor, a light sensor, and/or a docking station. Examples of the output devices may include, but are not limited to, the display screen 308, a projector screen, and/or a speaker.

The network interface 310 may comprise suitable logic, circuitry, interfaces, and/or code that may be configured to communicate with the messaging management system 102, via the communication network 106 (FIG. 1). The network interface 310 may be implemented by use of known technologies to support wired or wireless communication of the first CE device 104a with the communication network 106. The network interface 310 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

In operation, a user, such as the first user 108a, may utilize the I/O device 306, to provide an input to communicate one or more requests to subscribe for a service, such as the internet-based TV service, to the messaging management system 102. The processor 302 may be configured to render one or more UIs received from the messaging management system 102 to seek of user-information from the first user 108a at the time of subscription account creation, such as the first subscriber account 110a. In some embodiments, the user-information may be provided by use of the view application. The first user 108a, may utilize the I/O device 306, to provide an input to launch the view application stored in the memory 204. At the time of launch of the view application on the display screen 308, a personalized multimedia message may be rendered on the application interface of the view application that is displayed on the display screen 308. The personalized multimedia message may be received by the network interface 310, from the messaging management system 102, via the communication network 106. The received personalized multimedia message may be a personalized multimedia recommendation, an upsell message, or other customized message. For example, the personalized multimedia recommendation may be a promotion for a TV program, an upcoming TV event, an advertisement to upgrade existing subscription package, which is relevant to the first user 108a. Thereafter, the processor 302 may be configured to display a view that includes a plurality of icons to select a TV channel from a plurality of TV channels in accordance to the first subscriber account 110a. The network interface 310 may receive a stream of a TV channel based on the user-selection of an icon from the plurality of icons, from the media distribution system 112. In some embodiments, the personalized multimedia message may be received and displayed on the application interface rendered on the display screen 308 while the first user 108a is viewing the TV channel. The display of the personalized multimedia message may be controlled such that the personalized multimedia message is displayed in specified section of the application interface in accordance to instructions received from the messaging management system 102. The displayed personalized multimedia message within the application interface of the view application may assist the first user 108a to decide to take a further action. For example, the first user 108a may get motivated to view the promoted TV program or upgrade the existing subscription package from basic to premium.

FIGS. 4A and 4B are block diagrams that illustrate exemplary scenarios for implementation of the disclosed messaging management system and method for enhanced user engagement in a subscribed network, in accordance with an embodiment of the disclosure. FIGS. 4A and 4B are described in conjunction with elements from the FIGS. 1, 2, and 3.

With reference to FIG. 4A, there is shown a personalized multimedia message 404 on an exemplary application interface, such as an application interface 402. The personalized multimedia message 404 may be presented on the application interface 402 in a specified layout, which may include a text section 404a, an image section 404b, a first graphical icon 404c, and a second graphical icon 404d.

In accordance with the exemplary scenario, the TD detector 206 may be configured to analyze the input parameters for the plurality of users 108 associated with the plurality of subscriber accounts and the plurality of CE devices 104. An example of the input parameters are shown below in the table 1 and table 2.

TABLE 1

| Account_ID | Account_Type | Trial | Trial_product_code | Timeelapsed_days | Prod_Owned_1 | Prod_Owned_2 | Lifetime_value |
|---|---|---|---|---|---|---|---|
| A001 | B | 1 | T_01 | 6 | P1 | P2 | 9000 |
| A002 | E | 0 | NULL | NULL | P1 | NULL | 300 |
| A003 | B | 1 | T_02 | 3 | NULL | NULL | 1500 |
| . | . | . | . | . | . | . | . |
| . | . | . | . | . | . | . | . |
| . | . | . | . | . | . | . | . |
| A00n | N | 0 | NULL | NULL | P1 | NULL | 250 |

TABLE 2

| Account_ID | Device_ID | Device_type | Device_Ver | User_ID | User_type | Location_ID | Age_group | Gender |
|---|---|---|---|---|---|---|---|---|
| A001 | D1 | T1 | V4 | U_001 | M | L_001 | 31-40 | M |
| A001 | D2 | T2 | V1 | U_002 | C | L_001 | 13-19 | F |
| A002 | D3 | T1 | V4 | U_003 | M | L_002 | 20-30 | F |
| A003 | D4 | T3 | V3 | U_004 | M | L_003 | 20-30 | M |
| . | . | . | . | | . | . | . | |
| . | . | . | . | | . | . | . | |
| . | . | . | . | | . | . | . | |
| A00n | Dn | Tn | Vn | U_00N | M | L_00N | 41-55 | M |

In table 1, there is shown subscription account identifier (ID) (“Account_ID”) of each of the plurality of subscription accounts, the type of subscription account (Account_Type) as basic (B), premium or elite (E), and a product code (Trial_product_code) of a service or a product that is currently on trial (“1” may denote an ongoing trial whereas “0” may denote that no service or product are currently in trial period). With reference to table 1, there is also shown a time period (Timeelapsed_days) that is computed from a registration date for a trial of a product or a service associated with each subscriber account (Account_ID) of the plurality of subscriber accounts. The input parameters also includes the product code (such as “Prod_Owned_1” and “Prod_Owned_2”) of each product or service (such as “P1”, “P2”, . . . “PN”) owned by a user associated with each subscriber account. The input parameters may also include a lifetime value (Lifetime_value) associated with each subscriber account. The lifetime value may refer to a total monetary value that is spend by a user associated with a subscriber account (Account_ID). The lifetime value includes not only the monetary value spend on the service associated with the particular subscriber account (Account_ID) but also the monetary value spend on other products and services previously owned by the user. For example, the first user 108a may also own other products, such as a gaming console (which may have a product code of “P2”), from the same service provider or a related entity that provides the Internet-based TV service associated with the first subscriber account 110a.

In table 2, there is shown the subscription account IDs (Account_IDs) of each of the plurality of subscription accounts, which are common to both the table 1 and table 2 so that an associative relationship may be established between the table 1 and table 2 (a relational data structure). With reference to table 2, for each subscription account ID, there is shown one or more associated device IDs (Device_IDs) of each CE device of the plurality of CE devices 104, a device-type (Device_type), a device version (Device_Ver) of each CE device, a user ID (User_ID) of a user associated with each CE device, the user type, such as a master user (M) or a child user (C), a geographical location ID (Location_ID), an age group (Age_group), and a gender (Gender) of the user associated with each CE device. The input parameters includes not only the user-information of the plurality of users 108 retrieved from the memory 204, but may also computed parameters, for example, the time period (Timeelapsed_days) from the registration date for a trial of a product or a service associated with each subscriber account and lifetime value (Lifetime_value) associated with each subscriber account. The computed parameters may also be referred to as insights or derived input parameters.

For the sake of brevity, certain input parameters for the plurality of users 108 associated with the plurality of subscriber accounts and the plurality of CE devices 104, are shown in table 1 and table 2. There may be other input parameters, for example, user name, timestamp of subscription requests received from the plurality of CE devices 104, a registration date for a trial of a product or a service, a language preference, likes, dislikes, specified user-interests, version of the view application installed in each CE device of the plurality of CE devices 104, user-specified settings of each user related to a subscriber account of the plurality of subscriber accounts, a last change in viewing habits of a TV channel, a TV channel viewing (or a gameplay) trend of each user, an average time spend by each user to access a subscribed service related to the subscriber account of the plurality of subscriber accounts, relationship between different users associated with same subscriber account, such as relation between the first user 108a (user ID: “U_001”) and the second user 108b (user ID: “U_002”) of the first subscriber account 110a (Account_ID: “A001”). It is to be understood that there may be other input parameters without limiting the scope of the disclosure.

The TD detector 206 may be configured to classify the plurality of users 108, for example, U_001, U_002, . . . , U_00N, associated with the plurality of CE devices 104 and the plurality of subscriber accounts, for example, A001, A002, . . . , A00n. The plurality of users 108 may be classified based on the plurality of segmentation parameters and the input parameters. In some embodiments, one or more combination of the plurality of segmentation parameters may be used to filter the classified plurality of users 108. For example, users who are in their Xth day, for example 6^{th} Day, of their trial of a service (e.g. Timeelapsed_days=6 days) and who own a particular product (e.g. a “P4” product), may be selected as the target users. The TD detector 206 may be configured to identify a CE device, such as the first CE device 104a, or a target group of CE devices from the plurality of CE devices 104 based on the filtering and the plurality of segmentation parameters. The PMM controller 208 may be configured to generate, based on the plurality of segmentation parameters, the personalized multimedia message 404 specifically for identified CE device (such as the first CE device 104a) or the target group of CE devices of the plurality of CE devices 104.

The PMM controller 208 may be configured to control display of the personalized multimedia message 404 on the first CE device 104a associated with the first subscriber account 110a. In some embodiments, a view application may be installed in the first CE device 104a. The personalized multimedia message 404 may be directly presented on the first CE device 104a when the view application is launched on the first CE device 104a. Such personalized multimedia message 404 may be displayed on the first CE device 104a without the need for the first user 108a to go through a home screen of the subscribed service or any of intermediary services, for example, a search, explore, a view of channel page, TV programming page, programming guide, or the like. The personalized multimedia message 404 displayed on the application interface 402 is an example of a personalized recommendation to promote an ongoing TV show or a live event. The PMM controller 208 may be configured to determine a placement of different content types for display of the personalized multimedia message 404 based on a layout specified for the device-type of the identified CE device, such as the first CE device 104a. For example, in this case, the personalized multimedia message 404 is presented on the application interface 402 in a layout that specifies that the text section 404a, the image section 404b, the first graphical icon 404c, and the second graphical icon 404d are to be included in the personalized multimedia message 404 in specified arrangement, as shown in the FIG. 4A in an example. The user, such as the first user 108a, associated with the identified device, such as the first CE device 104a, may press or click the first graphical icon 404c (e.g. “watch Now”) to directly view the TV show or the live event that is recommended without the need to go through the home screen of the subscribed service associated with the first subscriber account 110a. When the first user 108a presses or clicks the first graphical icon 404c (e.g. “Watch Now”), a view request is transmitted to the media distribution system 112. The media distribution system 112 may be configured to stream the TV show or the live event to the first CE device 104a, thereby increasing the viewership for the promoted TV show or the live event. An option is also provided to the first user 108a to skip the recommended content, such as the personalized multimedia message 404, and go through the home screen of the subscribed service by a press or click of the second graphical icon 404d.

With reference to FIG. 4B, there is shown another personalized multimedia message 406 on an exemplary application interface, such as an application interface 402. The personalized multimedia message 406 may be presented on the application interface 402 in another specified layout, as shown. The personalized multimedia message 406 displayed on the application interface 402 is an example of an upsell message to suggest a user to upgrade existing subscription package, for example, from basic (B) to premium (E) subscription type. The TD detector 206 may be configured to detect that the subscription account with account IDs “A001” and “A003” have basic (B) subscription type, and both are in their first week of trial (Table 1). Thus, the CE devices associated with the account IDs “A001” and “A003”, may be retrieved. For example, the CE devices with device IDs, for example “D1”, “D2”, and “D4”, may be retrieved. However, the CE device with the device ID “D2” may be excluded for provisioning of the personalized multimedia message 406 as the user type of the user associated with the device ID “D2” is identified as a child user (or a sub-user). Thus, the CE device with the device ID “D2” may not be suited to display the upsell message as buying decision for the first subscriber account 110a may be vested with the master user (U_001) and not the child user (U_002) who is associated with the device ID “D2”, in reference to table 2. The PMM controller 208 may be configured to selectively provision the personalized multimedia message 406 to the target group of CE devices, such as the CE devices with device IDs, “D1”, and “D4”. The users associated with the target group of CE devices, such as the CE devices with device IDs, “D1”, and “D4”, may press or click a third graphical icon 406a (e.g. “But it Now”) to directly upgrade the subscription type from basic to premium subscription package without the need to go through the home screen of the subscribed service, such as the internet-based TV service. An option may also be provided to the first user 108a to skip the upsell message, such as the personalized multimedia message 406, and go through the home screen of the subscribed service by press or click of the second graphical icon 404d.

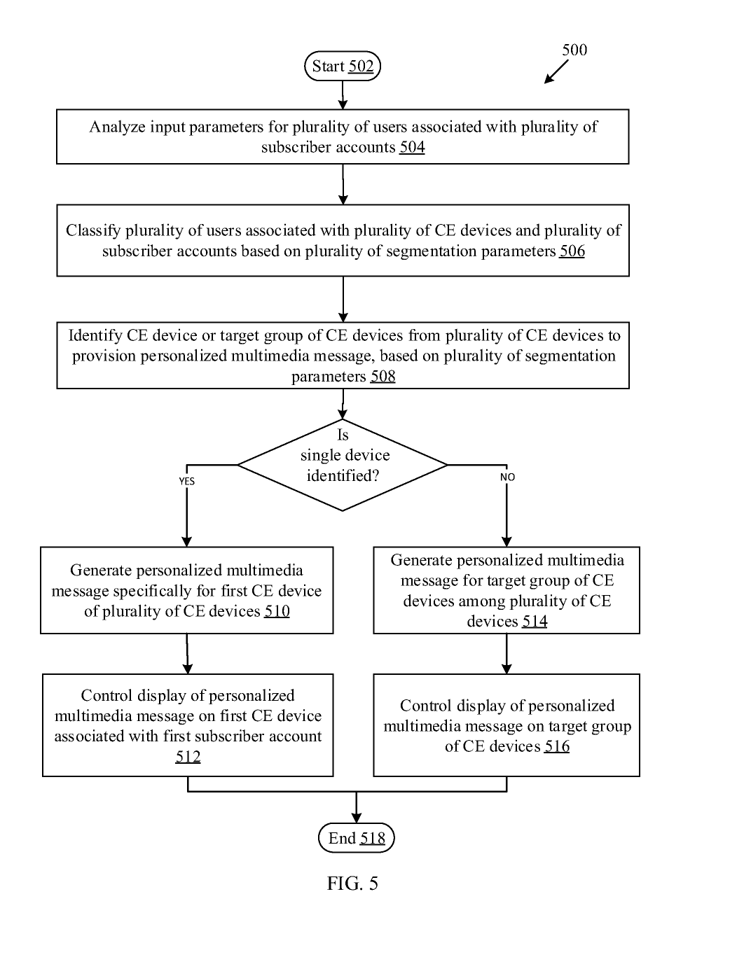

FIG. 5 is a flowchart that illustrates exemplary operations for messaging management in the messaging management system of FIG. 2, to provision personalized multimedia messages for enhanced user engagement in a subscribed network, in accordance with an embodiment of the disclosure. With reference to FIG. 5, there is shown a flow chart 500. The flow chart 500 is described in conjunction with FIGS. 1, 2, 3, 4A, and 4B. The method starts at 502 and proceeds to 504.

At 504, input parameters for the plurality of users 108 associated with the plurality of subscriber accounts, may be analyzed. The TD detector 206 may be configured to analyze the input parameters for the plurality of users 108 associated with the plurality of subscriber accounts and the plurality of CE devices 104. Examples of the input parameters has been described in FIG. 4A.

At 506, the plurality of users 108 associated with the plurality of CE devices 104 and the plurality of subscriber accounts may be classified based on the plurality of segmentation parameters. In accordance with an embodiment, the plurality of segmentation parameters for the plurality of users may correspond to a geographical location, an age group, a language preference, a gender, specified user-interests, a type of subscription account, and a device-type of the plurality of CE devices associated with the plurality of subscriber accounts. The plurality of segmentation parameters may further correspond to a list of products or services owned by each user associated with the plurality of subscriber accounts, a time period elapsed from a registration date for a trial of a product or a service associated with each of the plurality of subscriber accounts, and a lifetime value of each user associated with each of the plurality of subscriber accounts. The TD detector 206 may be configured to utilize the input parameters and the plurality of segmentation parameters for the classification of the plurality of users 108.

At 508, a CE device (such as the first CE device 104a) or a target group of CE devices from the plurality of CE devices 104 may be identified to provision a personalized multimedia message based on the plurality of segmentation parameters. The TD detector 206 may be configured to utilize one or more combination of the plurality of segmentation parameters to identify the CE device, such as the first CE device 104a, or the target group of CE devices from the plurality of CE devices 104. Target users from the plurality of users 108 may be identified based on the filtering of the plurality of users 108 associated with the plurality of subscriber accounts in accordance with the plurality of segmentation parameters. In instances where a single CE device is identified to provision a personalized multimedia message, the control may pass to 510, else to 514.

At 510, a personalized multimedia message may be generated specifically for the first CE device 104a (e.g. the identified CE device) of the plurality of CE devices 104. The personalized multimedia message may be generated and provisioned based on the plurality of segmentation parameters for the plurality of users 108. The first CE device 104a may be associated with the first subscriber account 110a of the plurality of subscriber accounts. In some embodiments, the personalized multimedia recommendation may be generated based on the device-type of the identified CE device and at least the list of products or services owned by a user associated with the subscriber account related to the identified CE device. In some embodiments, the personalized multimedia recommendation may be generated based on the device-type of the identified CE device and a time period elapsed from the registration date for the trial of a product or a service associated with the subscriber account related to the identified CE device. In some embodiments, the personalized multimedia recommendation may be generated based on the device-type of the identified CE device and a lifetime value of the user associated with the subscriber account related to the identified CE device.

In accordance with an embodiment, the TD detector 206 may be configured to detect a change in a selection of a subscription feature associated with the first subscriber account 110a in real time, near-real time, or a lag time. Thereafter, a personalized multimedia message may be generated and communicated in real time, near-real time or a lag time to the first CE device 104a associated with the first subscriber account 110a based on the detected change in the selection of the subscription feature associated with the first subscriber account 110a. In accordance with an embodiment, the TD detector 206 may be configured to detect a change in a trend in viewing habits of one or more users associated with the first subscriber account 110a. Thereafter, a personalized multimedia message may be generated and communicated in real time, near-real time or a lag time to the first CE device 104a associated with the first subscriber account 110a based on the detected change in the trend in viewing habits of the one or more users (such as the first user 108a and the second user 108b) associated with the first subscriber account 110a.

At 512, display of the personalized multimedia message on the first CE device 104a associated with the first subscriber account 110a, may be controlled. A placement of different content types for display of the personalized multimedia message may be determined based on a selected layout, from a plurality of specified layouts, specified for a device-type of the first CE device 104a.

At 514, a personalized multimedia message may be generated for a target group of CE devices from the plurality of CE devices 104 in accordance with the plurality of segmentation parameters. The generated personalized multimedia message(s) may be provisioned to the target group of CE devices. At 516, display of the personalized multimedia message on the target group of CE devices may be controlled. Control may pass to end 518 or return to 504.

In accordance with an embodiment of the disclosure, a messaging management system is disclosed. The messaging management system, such as the messaging management system 102 (shown in FIG. 1), may comprise one or more circuits, such as the processor 202, the TD detector 206, and the PMM controller 208 (shown in FIG. 2), that may be configured to generate, based on a plurality of segmentation parameters for the plurality of users 108, a personalized multimedia message specifically for the first CE device 104a of the plurality of CE devices 104. The first CE device 104a may be associated with the first subscriber account 110a of the plurality of subscriber accounts. The messaging management system 102 may be communicatively coupled to the plurality of CE devices 104. The PMM controller 208 may be configured to control display of the personalized multimedia message on the first CE device 104a associated with the first subscriber account 110a.

Various embodiments of the disclosure may provide a non-transitory computer-readable medium and/or storage medium, wherein there is stored thereon, a machine code and/or a set of instructions executable by a machine and/or a computer to generate, based on a plurality of segmentation parameters for the plurality of users 108, a personalized multimedia message specifically for the first CE device 104a of the plurality of CE devices 104. The first CE device 104a may be associated with the first subscriber account 110a of the plurality of subscriber accounts. Display of the personalized multimedia message may be controlled on the first CE device 104a that is associated with the first subscriber account 110a.

Based on the display of the personalized multimedia message, it may be convenient for a user, such as the first user 108a, to decide whether to view the recommended TV program or live event, upgrade the existing subscription type, or be informed of the real events in advance. The display of the personalized multimedia message may provide a meliorated user experience and enhance user engagement. The individualization or personalization of the displayed multimedia message may not only encourage the users to spend more time in the subscribed network but also emotionally tie the consumer(s) closer to the subscribed product or service.

Currently, conventional systems usually pre-process the user-information filled in user-profiles, such as in social network profiles or other profiles, for user segmentation and targeting. Due to lack of accurate insights, many of the conventional consumer engagement techniques and practices that supported the consumer engagement online or offline, have become less effective in recent years. In contrast, the disclosed messaging management system 102 performs an effective and efficient extraction of input parameters for the plurality of users 108, and detects changes associated with the plurality of subscriber accounts in real time or near-real time. The operations performed by the processor 202, the TD detector 206, and/or the PMM controller 208, provides an ability to the messaging management system 102 to accurately and efficiently identify an appropriate consumer at an appropriate time and to provision a suitable type of personalized multimedia message in a subscribed network associated with a subscriber account. For example, the TD detector 206 and the PMM controller 208 of the messaging management system 102 effectively solves a particular technological problem of how to identify a target user from millions of users associated with millions of subscriber accounts, what content to generate to engage the identified user, and when to provision the generated personalized content for enhanced user engagement. The ability of the messaging management system 102 to personalize the multimedia content and the right timing of the provisioning of the multimedia content for each CE devices improves engagement and emotional attachment of the consumer(s) to the subscribed product or service.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system, comprising:
one or more processors in a messaging management system that handle user-information for a plurality of users associated with a plurality of subscriber accounts, said one or more processors are configured to:
generate, based on a plurality of segmentation parameters for said plurality of users, a personalized multimedia message for a first consumer electronic (CE) device of a plurality of CE devices, wherein said first CE device is associated with a first subscriber account of said plurality of subscriber accounts; and
control display of said personalized multimedia message on said first CE device associated with said first subscriber account.

2. The system according to claim 1, wherein said plurality of segmentation parameters for said plurality of users correspond to one or more of: a geographical location, an age group, a language preference, a gender, specified user-interests, a type of subscription account, and a device-type of said plurality of CE devices associated with said plurality of subscriber accounts.

3. The system according to claim 2, wherein said plurality of segmentation parameters further correspond to a list of products or services owned by a user associated with said first subscriber account, a time period elapsed from a registration date for a trial of a product or a service associated with said first subscriber account, and a life-time value of said user associated with said first subscriber account.

4. The system according to claim 1, wherein said one or more processors are configured to classify said plurality of users associated with said plurality of CE devices and said plurality of subscriber accounts based on said plurality of segmentation parameters.

5. The system according to claim 1, wherein said one or more processors are further configured to generate said personalized multimedia message based on a device-type of said first CE device and at least a list of products or services owned by a user associated with said first subscriber account.

6. The system according to claim 5, wherein said one or more processors are further configured to generate said personalized multimedia message based on said device-type of said first CE device and a time period elapsed from a registration date for a trial of a product or a service associated with said first subscriber account.

7. The system according to claim 1, wherein said one or more processors are further configured to generate said personalized multimedia message based on a device-type of said first CE device and a life-time value of a user associated with said first subscriber account.

8. The system according to claim 1, wherein said one or more processors are further configured to provision a multimedia recommendation to a target group of CE devices among said plurality of CE devices in accordance with said plurality of segmentation parameters.

9. The system according to claim 1, wherein said one or more processors are further configured to detect a change in a selection of a subscription feature associated with said first subscriber account in real time, near-real time, or a lag time.

10. The system according to claim 9, wherein said one or more processors are further configured to generate and communicate said personalized multimedia message in real time, near-real time or a lag time to said first CE device associated with said first subscriber account based on said detected change in said selection of said subscription feature associated with said first subscriber account.

11. The system according to claim 1, wherein said one or more processors are further configured to detect a change in a trend in viewing habits of one or more users associated with said first subscriber account.

12. The system according to claim 11, wherein said one or more processors are further configured to generate and communicate said personalized multimedia message to said first CE device associated with said first subscriber account based on said detected change in said trend in viewing habits of said one or more users associated with said first subscriber account.

13. The system according to claim 1, wherein said one or more processors are further configured to determine a placement of different content types for display of said personalized multimedia message based on a selected layout, from a plurality of specified layouts, specified for a device-type of said first CE device.

14. A method, comprising:
in a messaging management system that handles user-information for a plurality of users associated with a plurality of subscriber accounts:
generating, by one or more processors in said messaging management system, based on a plurality of segmentation parameters for said plurality of users, a personalized multimedia message for a first consumer electronic (CE) device of a plurality of CE devices, wherein said first CE device is associated with a first subscriber account of said plurality of subscriber accounts; and
controlling, by said one or more processors, display of said personalized multimedia message on said first CE device associated with said first subscriber account.

15. The method according to claim 14, further comprising classifying, by said one or more processors, said plurality of users associated with said plurality of CE devices and said plurality of subscriber accounts based on said plurality of segmentation parameters.

16. The method according to claim 14, further comprising generating, by said one or more processors, said personalized multimedia message based on a device-type of said first CE device and at least a list of products or services owned by a user associated with said first subscriber account.

17. The method according to claim 14, further comprising generating, by said one or more processors, said personalized multimedia message based on a device-type of said first CE device and a time period elapsed from a registration date for a trial of a product or a service associated with said first subscriber account.

18. The method according to claim 14, further comprising generating, by said one or more processors, said personalized multimedia message based on a device-type of said first CE device and a life-time value of a user associated with said first subscriber account.

19. The method according to claim 14, further comprising provisioning, by said one or more processors, a multimedia message that includes at least one of a multimedia recommendation, an upsell message, or a customized message, to a target group of CE devices among said plurality of CE devices in accordance with said plurality of segmentation parameters.

20. The method according to claim 14, further comprising detecting, by said one or more processors, a change in a selection of a subscription feature associated with said first subscriber account in real time, near-real time, or a lag time.

21. The method according to claim 20, further comprising generating and communicating, by said one or more processors, said personalized multimedia message in real time, near-real time or a lag time to said first CE device associated with said first subscriber account based on said detected change in said selection of said subscription feature associated with said first subscriber account.

22. The method according to claim 14, further comprising detecting, by said one or more processors, a change in a trend in viewing habits of one or more users associated with said first subscriber account.

23. The method according to claim 22, further comprising generating and communicating, by said one or more processors, said personalized multimedia message to said first CE device associated with said first subscriber account based on said detected change in said trend in said viewing habits of said one or more users associated with said first subscriber account.
